(19) United States
(12) Patent Application Publication
(10) Pub. No.: US 2012/0038728 A1
(43) Pub. Date: Feb. 16, 2012

(54) PRINTING DEVICE WITH MARKING FUNCTION

(75) Inventor: Yi-Liang Chen, Taipei (TW)

(73) Assignee: PRIMAX ELECTRONICS LTD., TAIPEI (TW)

(21) Appl. No.: 12/908,743

(22) Filed: Oct. 20, 2010

(30) Foreign Application Priority Data
Aug. 13, 2010 (TW) 099215570

(51) Int. Cl. B41J 2/01

(52) U.S. Cl. 347/107

(57) ABSTRACT

A printing device with a marking function is provided. The printing device includes a printing module, an identification module and a marking member. The printing module is used for printing images on a transfer paper, thereby producing a barcode paper. The identification module is used for scanning the barcode paper, and judging the printing quality of the barcode paper. If the printing quality of the barcode paper is unqualified, the marking member produces a mark on the barcode paper. In addition, the barcode paper is successively transported through the printing module, the identification module and the marking member.

### FIELD OF THE INVENTION

The present invention relates to a printing device, and more particularly to a printing device with a marking function.

### BACKGROUND OF THE INVENTION

Printing devices are peripherals for printing characters and/or graphics on papers or other kinds of printing media. Generally, the printing devices are classified into two types: ordinary printing devices and thermal transfer printing devices.

The configurations of the thermal transfer printing devices are substantially identical to those of the ordinary printing devices except for the way of printing on the media. For example, the ordinary printing device supplies ink or toner onto a paper. Whereas, a thermal transfer printing device uses a thermal print head (TPH) to heat a ribbon to allow the coating of the ribbon to be adsorbed on a transfer paper. The common thermal transfer printing devices include for example faxing machines, the POS (Point of Sale) printers and barcode printers.

The conventional thermal transfer printing devices have been widely used. Among these conventional thermal transfer printing devices, since the barcode printers are usually used to print images on so many barcode papers, the long-term uses of the barcode printers may cause deteriorated printing quality. For checking the printing quality of the barcode paper, the printed barcode papers should be one by one examined with the naked eyes to find the barcode papers that have much inferior printing quality. Since some defective barcode papers fail to be directly examined with the naked eyes, an additional scanning device should be used to examine the barcode papers. In other words, the process of examining the barcode papers is very time-consuming and the process of operating the scanning device is labor-intensive. For solving these drawbacks, it is necessary to develop a thermal transfer printing device having the functions of examining the printing quality and marking the unqualified barcode papers.

Recently, a thermal transfer printing device with a marking function has been disclosed and commercially available. FIG. 1 is a schematic side view illustrating a thermal transfer printing device with a marking function according to the prior art. FIG. 2 is a schematic side view illustrating the thermal transfer printing device of FIG. 1 and taken along another viewpoint. Please refer to FIGS. 1 and 2. The thermal transfer printing device 1 comprises a casing 10, a thermal transfer printing module 11, a first power-providing device 12, a first gear set 13, a second power-providing device 14, a second gear set 15, a third power-providing device 16, a transmission mechanism 17, an external identification module 18 and a controlling unit 19. The thermal transfer printing module 11 comprises a ribbon transport module 111, a transfer paper transport module 112, a thermal print head 113 and a print roller 114. A ribbon R of the ribbon transport module 111 is transported through the region between the thermal print head 113 and the print roller 114. Similarly, a transfer paper M of the transfer paper transport module 112 is transported through the region between the thermal print head 113 and the print roller 114. The transfer paper M comprises a releasing paper part M1 and a medium part M2. The medium part M2 is disposed over the releasing paper part Ml. The thermal print head 113 is used for heating the ribbon R to allow the coating of the ribbon R to be adsorbed on the medium part M2 of the transfer paper M. In such way, a thermal transfer printing operation is performed to print the medium part M2 as a barcode paper M3. The print roller 114 is used for transporting the ribbon R and the transfer paper M and facilitating the thermal print head 113 to stably perform the thermal transfer printing operation.

As shown in FIG. 1, the ribbon transport module 111 comprises a ribbon supplying terminal 1111, a ribbon recovering terminal 1112, a first tension shaft 1113 and a second tension shaft 1114. The ribbon R is stored in the ribbon supplying terminal 1111. An end of the ribbon R is wound around and the fixed in the ribbon recovering terminal 1112. Due to the first tension shaft 1113 and the second tension shaft 1114, a tension force is exerted on the ribbon R. When the ribbon supplying terminal 1111 is driven to rotate, the ribbon R is transmitted from the ribbon supplying terminal 1111 to the ribbon recovering terminal 1112. The transfer paper transport module 112 comprises a transfer paper supplying terminal 1121, a transfer paper recovering terminal 1122, a third tension shaft 1123 and a fourth tension shaft 1124. The configurations and functions of the transfer paper transport module 112 are very similar to the ribbon transport module 111. The transfer paper M is stored in the transfer paper supplying terminal 1121. An end of the transfer paper M is wound around and the fixed in the transfer paper recovering terminal 1122. Due to the third tension shaft 1123 and the fourth tension shaft 1124, a tension force is exerted on the transfer paper M. When the transfer paper recovering terminal 1122 is driven to rotate, the transfer paper M is transmitted from the transfer paper supplying terminal 1121 to the transfer paper recovering terminal 1122.

As shown in FIG. 2, the external identification module 18 is disposed on the casing 10 and arranged outside the casing 10. The external identification module 18 is used for scanning the printed barcode paper M3. For example, the external identification module 18 is a scanning module. From the relative locations as shown in FIGS. 1 and 2, the first gear set 13 is connected with the ribbon recovering terminal 1112, the second gear set 15 is connected with the transfer paper recovering terminal 1122, and the transmission mechanism 17 is connected with the print roller 114. The first power-providing device 12 is connected with the first gear set 13 for providing motive power to the first gear set 13 to drive rotation of the ribbon recovering terminal 1112. The second power-providing device 14 is connected with the second gear set 15 for providing motive power to the second gear set 15 to drive rotation of the transfer paper recovering terminal 1122. In addition, the third power-providing device 16 is connected with the transmission mechanism 17 for providing motive power to the transmission mechanism 17 to drive rotation of the print roller 114. For example, the first power-providing device 12, the second power-providing device 14 and the third power-providing device 16 are motors. The controlling unit 19 is connected with the first power-providing device 12, the second power-providing device 14, the third power-providing device 16 and the external identification module 18 for enabling or disabling the first power-providing device 12, the second power-providing device 14 and the third power-providing device 16, and judging whether the printing quality of the barcode paper M3 is acceptable or unqualified.

During operations of the thermal transfer printing device 1, the first power-providing device 12, the second power-providing device 14 and the third power-providing device 16 are enabled. As such, the ribbon R is transmitted from the ribbon supplying terminal 1111 to the ribbon recovering terminal 1112, and the transfer paper M is transmitted from the transfer paper supplying terminal 1121 to the transfer paper recovering terminal 1122. At the same time, the print roller 114 is rotated. When the transfer paper M is transported through the region between the thermal print head 113 and the print roller 114, the thermal print head 113 performs a thermal transfer printing operation. In such way, the medium part M2 of the transfer paper M is printed as a barcode paper M3. As the print roller 114 and the transfer paper recovering terminal 1122 are continuously rotated, the releasing paper part M1 is detached from the barcode paper M3. The releasing paper part M1 is transmitted to the transfer paper recovering terminal 1122, but the barcode paper M3 is ejected out of the casing 10. When the barcode paper M3 is ejected out of the casing 10, a light beam B emitted from the external identification module 18 is projected on the barcode paper M3 to scan the barcode paper M3. According to the scanned image of the barcode paper M3, the controlling unit 19 will judge whether the scanning quality is acceptable. If the controlling unit 19 judges that the scanning quality is acceptable, the barcode paper M3 is continuously ejected out of the casing 10 and departed from the thermal transfer printing device 1. Whereas, if the controlling unit 19 judges that the scanning quality is not acceptable, the controlling unit 19 will control a reverse rotation of the print roller 114. Upon the reverse rotation of the print roller 114, the barcode paper M3 is transmitted to the region between the between the thermal print head 113 and the print roller 114, and the thermal print head 113 performs a thermal transfer printing operation on the barcode paper M3. In such way, an unqualified mark is printed on the barcode paper M3. The barcode paper M3 with the unqualified mark is then ejected to be identified by the user.

According to the above operating method of the conventional thermal transfer printing device, the user may identify the scanning quality of the barcode paper by judging whether the barcode paper has any unqualified mark. Although the conventional thermal transfer printing device has the functions of examining the printing quality and marking the unqualified barcode papers, there are still some drawbacks. For example, when the unqualified mark is printed on the unqualified barcode paper by the conventional thermal transfer printing device, the print roller should be controlled to be reversely rotated to have the unqualified barcode paper pass through the thermal print head again. In addition, after the unqualified mark is printed on the unqualified barcode paper, the print roller should be controlled to be normally rotated to eject the unqualified barcode paper. In other words, for printing the unqualified mark by the conventional thermal transfer printing device, the controlling unit should perform precise computation and accurately cooperate with the print roller. For avoiding erroneous operation, the reliability of the conventional thermal transfer printing device should be extremely high.

Moreover, since the transfer paper needs to be returned to the location of the thermal print head when the unqualified mark is printed by the conventional thermal transfer printing device, the unqualified mark by the conventional thermal transfer printing device should have plural power-providing device. For avoiding bending the ribbon and transfer paper and eliminating occurrence of the mutual interference between the ribbon and transfer paper, while the transfer paper is returned back to the print roller, the ribbon transfer module and the transfer paper transport module are not moved. However, during the transfer paper is returned back, the transfer paper between the thermal print head and the transfer paper supplying terminal is easily bent to lose the tension force. Under this circumstance, the transfer paper is possibly damage and thus the printing quality is impaired.

### SUMMARY OF THE INVENTION

The present invention provides a printing device with a marking function, which the process of printing a mark is performed without complex control and computation.

The present invention also provides a printing device with a marking function, in which the process of producing the unqualified mark is performed without the need of returning back the transfer paper.

In accordance with an aspect of the present invention, there is provided a printing device with a marking function. The printing device includes a printing module, an identification module, a power-providing device and a marking member. The printing module is used for performing a printing operation to produce a barcode paper, and transporting the barcode paper. The identification module is disposed beside the printing module, and has a preset barcode image. According to the preset barcode image, the identification module judges whether the barcode paper is identical to the preset barcode image. The power-providing device is connected with the printing module and the identification module for providing motive power to the printing module and the identification module. The marking member is connected with the identification module. If the identification module judges that the barcode paper is different from the preset barcode image, the marking member produces a mark on the barcode paper. The barcode paper is successively transported through the printing module, the identification module and the marking member.

In an embodiment, the printing module includes a ribbon transport module, a transfer paper transport module, a thermal print head and a print roller. The ribbon transport module is used for transmitting a ribbon from a ribbon supplying terminal to a ribbon recovering terminal. The transfer paper transport module is used for transmitting a transfer paper from a transfer paper supplying terminal to a transfer paper recovering terminal. The transfer paper includes a releasing paper part and a medium part disposed on the releasing paper part. The thermal print head is arranged between the ribbon transport module and the transfer paper transport module for performing the printing operation on the medium part of the transfer paper through the ribbon, thereby printing the medium part as the barcode paper. The print roller is arranged beside the thermal print head for transporting the transfer paper, so that the transfer paper is transmitted to the identification module.

In an embodiment, the ribbon transport module includes a first tension shaft and a second tension shaft. The first tension shaft is arranged between the ribbon supplying terminal and the thermal print head for applying a first tension force to the ribbon. The second tension shaft is arranged between the thermal print head and the ribbon recovering terminal for applying the first tension force to the ribbon.

In an embodiment, the transfer paper transport module includes a third tension shaft and a fourth tension shaft. The third tension shaft is arranged between the transfer paper supplying terminal and the thermal print head for applying a second tension force to the transfer paper. The fourth tension shaft is arranged between the thermal print head and the transfer paper recovering terminal for applying the second tension force to the transfer paper.

In an embodiment, the printing device further includes a sensor, which is connected with the printing module for detecting a thickness of the transfer paper. When the thickness of the transfer paper detected by the sensor is changed from a first thickness to a second thickness greater than the first thickness, the sensor issues a driving signal to the printing module to enable the printing module. The first thickness is equal to a thickness of the releasing paper part. The second thickness is equal to an overall thickness of the medium part and the releasing paper part.

In an embodiment, the identification module includes a scanning element, a controlling unit, a first transport roller assembly and a second transport roller assembly. The scanning element is used for scanning the barcode paper, thereby acquiring a scanned barcode image. The controlling unit is connected with the scanning element, and stores the preset barcode image. By comparing the scanned barcode image with the preset barcode image, the controlling unit judges whether the scanned barcode image is identical to the preset barcode image. The first transport roller assembly is arranged at a first side of the scanning element for transporting the barcode paper through the scanning element. The second transport roller assembly is arranged at a second side of the scanning element for transporting the barcode paper to be departed from the scanning element.

In an embodiment, the scanning element is a contact image sensor (CIS).

In an embodiment, the marking member includes a marking head and a solenoid valve. The marking head is used for producing a mark on the barcode paper. The solenoid valve is connected with the marking head for moving the marking head upwardly and downwardly with respect to the barcode paper.

In an embodiment, the marking head is a seal, a punching head or a trimming knife, and the mark is an unqualified symbol, an opening or a notch.

In an embodiment, the printing device further includes a gear set. The gear set is connected with the power-providing device, the printing module and the identification module for receiving the motive power from the power-providing device, and transmitting the motive power to the printing module and the identification module.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a thermal transfer printing device with a marking function according to the prior art;

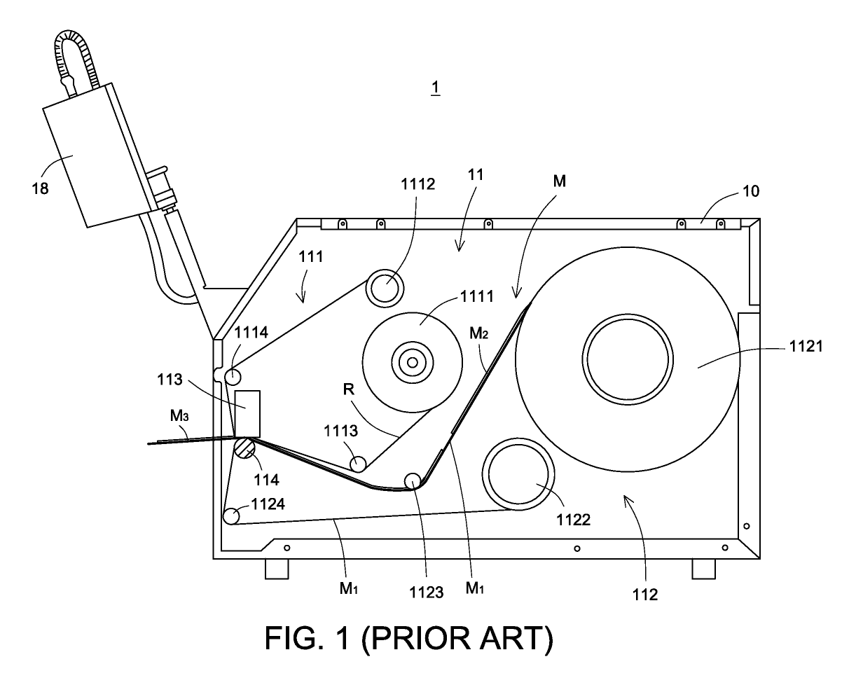

FIG. 2 is a schematic side view illustrating the thermal transfer printing device of FIG. 1 and taken along another viewpoint;

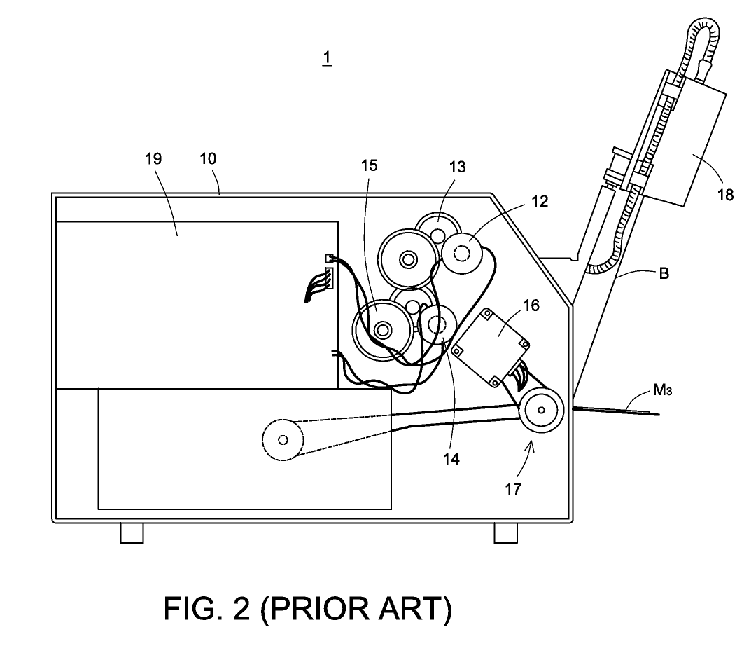

FIG. 3 is a schematic side view illustrating the outward appearance of a transfer paper used in a thermal transfer printing device with a marking function according to an embodiment of the present invention;

FIG. 4 is a schematic side view illustrating a printing device with a marking function according to an embodiment of the present invention; and

FIG. 5 is a schematic side view illustrating the printing device of FIG. 4 and taken along another viewpoint.

### DETAILED DESCRIPTION OF THE PREFERRED EMBODIMENT

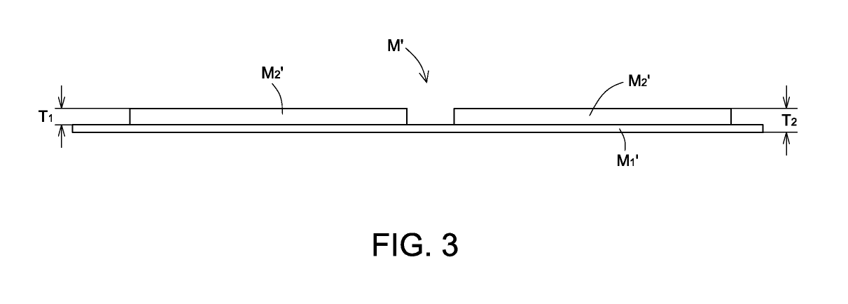

For obviating the drawbacks encountered from the prior art, the present invention provides a printing device with a marking function. FIG. 3 is a schematic side view illustrating the outward appearance of a transfer paper used in a thermal transfer printing device with a marking function according to an embodiment of the present invention. As shown in FIG. 3, the transfer paper M′ comprises a releasing paper part M1′ and a medium part M2′ disposed on the releasing paper part M1′. The top surface of the medium part M2′ is a blank surface. The bottom surface of the medium part M2′ is coated with an adhesive, so that the medium part M2′ may be adhered to the releasing paper part M1′. As shown in FIG. 3, the releasing paper part M1′ has a first thickness T1. In addition, the releasing paper part M1′ is stacked on the medium part M2′, and the overall thickness of the transfer paper M′ is equal to a second thickness T2.

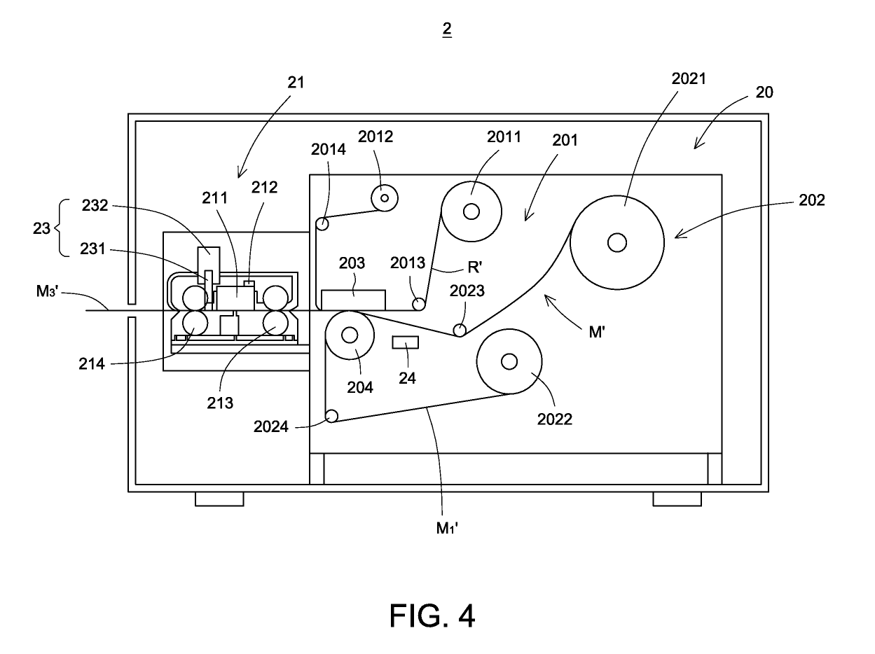

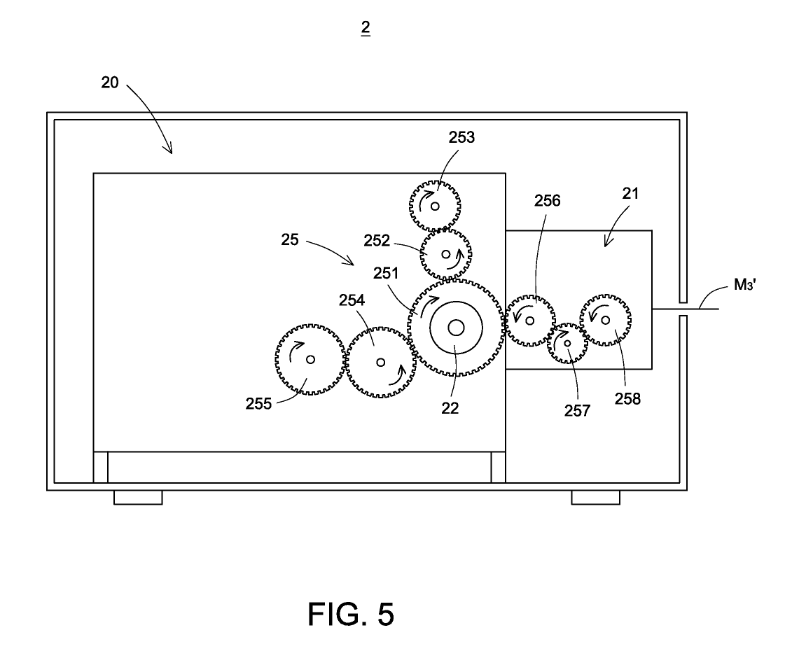

Hereinafter, the configurations of the printing device 2 with a marking function according to the present invention will be illustrated with reference to FIGS. 4 and 5. FIG. 4 is a schematic side view illustrating a printing device with a marking function according to an embodiment of the present invention. FIG. 5 is a schematic side view illustrating the printing device of FIG. 4 and taken along another viewpoint. The printing device 2 comprises a printing module 20, an identification module 21, a power-providing device 22, a marking member 23, a sensor 24 and a gear set 25. The printing module 20 is used for printing images on the blank medium part M2′ to produce a barcode paper M3′ (i.e. a printed medium part M2′), and transporting the barcode paper M3′. The identification module 21 is arranged beside the printing module 20. In addition, the identification module 21 has a preset barcode image. According to the preset barcode image, the identification module 21 may judge whether the barcode paper M3′ is identical to the preset barcode image. The power-providing device 22 is connected with the printing module 20 and the identification module 21 for providing motive power to the printing module 20 and the identification module 21. The marking member 23 is connected with the identification module 21. In a case that the identification module 21 judges that the barcode paper M3′ is different from the preset barcode image, the marking member 23 produces a mark on the barcode paper M3′. The sensor 24 is connected with the printing module 20 and arranged in the vicinity of the printing module 20 for detecting the thickness of the transfer paper M′. The gear set 25 is connected with the power-providing device 22, the printing module 20 and the identification module 21 for receiving the motive power from the power-providing device 22, and transmitting the motive power to the printing module 20 and the identification module 21.

The detailed structures of the components of the printing device 2 will be illustrated as follows. As shown in FIG. 4, the printing module 20 comprises a ribbon transport module 201, a transfer paper transport module 202, a thermal print head 203 and a print roller 204. By the ribbon transport module 201, a ribbon R′ is transmitted from a ribbon supplying terminal 2011 to a ribbon recovering terminal 2012. By the transfer paper transport module 202, the transfer paper M′ is transmitted from a transfer paper supplying terminal 2021 to a transfer paper recovering terminal 2022. The thermal print head 203 is arranged between the ribbon transport module 201 and the transfer paper transport module 202 for printing images on the medium part M2′ of the transfer paper M′ through the ribbon R′. In such way, a thermal transfer printing operation is performed to print the medium part M2′ as the barcode paper M3′. The print roller 204 is arranged beside the thermal print head 203 for transporting the transfer paper M′, so that the barcode paper M3′ of the transfer paper M′ is transmitted to the identification module 21 and the releasing paper part M1′ of the transfer paper M′ is transmitted to the transfer paper recovering terminal 2022.

Please refer to FIG. 4 again. In addition to the ribbon supplying terminal 2011 and the ribbon recovering terminal 2012, the ribbon transport module 201 further comprises a first tension shaft 2013 and a second tension shaft 2014. The first tension shaft 2013 is arranged between the ribbon supplying terminal 2011 and the thermal print head 203 for applying a first tension force to the ribbon R′. The second tension shaft 2014 is arranged between the thermal print head 203 and the ribbon recovering terminal 2012 for applying the first tension force to the ribbon R′. In addition to the transfer paper supplying terminal 2021 and the transfer paper recovering terminal 2022, the transfer paper transport module 202 further comprises a third tension shaft 2023 and a fourth tension shaft 2024. The third tension shaft 2023 is arranged between the transfer paper supplying terminal 2021 and the thermal print head 203 for applying a second tension force to the transfer paper M′. The fourth tension shaft 2024 is arranged between the thermal print head 203 and the transfer paper recovering terminal 2022 for applying the second tension force to the transfer paper M′.

The identification module 21 comprises a scanning member 211, a controlling unit 212, a first transport roller assembly 213 and a second transport roller assembly 214. The scanning element 211 is used for scanning the barcode paper M3′, thereby acquiring a scanned barcode image. The controlling unit 212 is connected with the scanning element 211. The preset barcode image is stored in the controlling unit 212. By comparing the scanned barcode image with the preset barcode image, the controlling unit 212 may judge whether the scanned barcode image is identical to the preset barcode image. In this embodiment, the scanning element 211 is a contact image sensor (CIS), and the controlling unit 212 is a microprocessor. The first transport roller assembly 213 is arranged at a first side of the scanning element 211 for transporting the barcode paper M3′ through the scanning element 211. The second transport roller assembly 214 is arranged at a second side of the scanning element 211 for transporting the barcode paper M3′ to be departed from the scanning element 211.

The marking member 23 comprises a marking head 231 and a solenoid valve 232. The marking head 231 is used for producing a mark on the barcode paper M3′. The solenoid valve 232 is connected with the marking head 231 for moving the marking head 231 upwardly and downwardly with respect to the barcode paper M3′. The marking head 231 is for example a seal, a punching head, a trimming knife or any other marking tool. Corresponding to the marking head 231, the mark is an unqualified symbol, an opening or a notch. In this embodiment, the marking head 231 is a punching head, and the mark is an opening.

Please refer to FIG. 5. The gear set 25 comprises a driving gear 251, a first adjusting gear 252, a ribbon driving gear 253, a second adjusting gear 254, a transfer paper driving gear 255, a first transmission gear 256, a third adjusting gear 257 and a second transmission gear 258. The power-providing device 22 is connected with the driving gear 251 to rotate the driving gear 251 in the clockwise direction (in the viewpoint of FIG. 5). In this embodiment, the power-providing device 22 is a motor.

The mechanism of receiving the motive power by the printing module 20 will be illustrated as follows. Since the first adjusting gear 252 is engaged with the driving gear 251, the first adjusting gear 252 is synchronously rotated with the driving gear 251. In addition, since the first adjusting gear 252 is engaged with the ribbon driving gear 253, the ribbon driving gear 253 is rotated with the first adjusting gear 252. In this embodiment, the first adjusting gear 252 is rotated in the anti-clockwise direction, and the ribbon driving gear 253 is rotated in the clockwise direction. Since the ribbon driving gear 253 is connected with the ribbon recovering terminal 2012, the ribbon R is transported to the ribbon recovering terminal 2012 upon rotation of the ribbon recovering terminal 2012. Similarly, since the second adjusting gear 254 is engaged with the driving gear 251, the second adjusting gear 254 is synchronously rotated with the driving gear 251. In addition, since the second adjusting gear 254 is engaged with the transfer paper driving gear 255, the transfer paper driving gear 255 is rotated with the second adjusting gear 254. In this embodiment, the second adjusting gear 254 is rotated in the anti-clockwise direction, and the transfer paper driving gear 255 is rotated in the clockwise direction. Since the transfer paper driving gear 255 is connected with the transfer paper recovering terminal 2022, the releasing paper part M1′ of the transfer paper M′ is transported to the transfer paper recovering terminal 2022 upon rotation of the transfer paper recovering terminal 2022.

The mechanism of receiving the motive power by the identification module 21 will be illustrated as follows. The first transmission gear 256 is connected with the first transport roller assembly 213, and the second transmission gear 258 is connected with the second transport roller assembly 214. Since the first transmission gear 256 is engaged with the driving gear 251, the first transmission gear 256 is synchronously rotated with the driving gear 251. In addition, since the third adjusting gear 257 is engaged with the second transmission gear 258, the second transmission gear 258 is rotated with the third adjusting gear 257. In this embodiment, the third adjusting gear 257 is rotated in the clockwise direction, and the first transmission gear 256 and the second transmission gear 258 are rotated in the anti-clockwise direction. Consequently, as the first transmission gear 256 and the second transmission gear 258, the barcode paper M3′ will be transported. From FIG. 5, it is noted that the power-providing device 22 is connected with the printing module 20 and the identification module 21 through the gear set 25 for providing the motive power to the printing module 20 and the identification module 21.

Hereinafter, the operations of the printing device 2 with the marking function will be illustrated with reference to FIGS. 4 and 5. During the operation of the printing device 2, the printing module 20 and the identification module 21 are enabled, so that the transfer paper M′ and the ribbon R′ are transported through the region between the thermal print head 203 and the print roller 204. If the passage of the transfer paper M′ and the first thickness T1 of the transfer paper M′ are detected by the sensor 24, it means that only the releasing paper part M1′ of the transfer paper M′ (excluding the medium part M2′) passes through the sensor 24. Whereas, if the second thickness T2 of the transfer paper M′ is detected by the sensor 24, it means that the combination of the releasing paper part M1′ and the medium part M2′ passes through the sensor 24. In this situation, the sensor 24 issues a driving signal to the printing module 20. At the moment when the printing module 20 is enabled, the controlling unit 212 starts to count time. After the controlling unit 212 has counted time for a predetermined time period, the scanning element 211 is enabled by the controlling unit 212 to perform a scanning operation.

After the printing module 20 is enabled, the thermal print head 203 will heat the ribbon R′ to allow the coating of the ribbon R′ to be adsorbed on the medium part M2′ of the transfer paper M′. In such way, a thermal transfer printing operation is performed to print the medium part M2′ as a barcode paper M3′. In addition, the print roller 204 may facilitate the thermal print head 203 to perform the thermal transfer printing operation and transport the transfer paper M′. Consequently, the releasing paper part M1′ is transmitted to the transfer paper recovering terminal 2022, and the barcode paper M3′ is transmitted to the identification module 21. After the barcode paper M3′ is transmitted to the identification module 21 for the predetermined time period, the scanning element 211 is enabled to perform the scanning operation. Next, the barcode paper M3′ is transported through the scanning element 211 by the first transport roller assembly 213, so that the barcode paper M3′ is scanned by the scanning element 211 to acquire the scanned barcode image. Then, the scanned barcode image is compared with the preset barcode image. If the controlling unit 212 judges that the scanned barcode image from the barcode paper M3′ is identical to the preset barcode image, the marking element 23 is disabled and the barcode paper M3′ is continuously transported by the second transport roller assembly 214 to be departed from the printing module 20. Whereas, if the scanned barcode image is different from the preset barcode image, the solenoid valve 232 of the marking member 23 is enabled. Then, the marking head 231 connected with the solenoid valve 232 is moved downwardly to contact with the barcode paper M3′ and punch an opening in the barcode paper M3′, and the barcode paper M3′ is transported by the second transport roller assembly 214 to be departed from the printing module 20. In such way, the user may realize whether the barcode paper M3′ is qualified or not according to the presence or absence of the opening in the barcode paper M3′.

From the above description, the printing device of the present invention has a marking function. Since the identification module and the marking member are arranged at a downstream side of the printing module, the barcode paper is successively transported through the printing module, the identification module and the marking member. In this situation, if the barcode paper is deemed to be unqualified, the barcode paper dose not need to be returned back. On the other hand, the barcode paper is continuously moved forwardly and then the marking member produces the mark on the unqualified barcode paper. In other words, the printing device of the present invention does not need complex control and precise computation to process the unqualified barcode paper. Consequently, the printing device of the present invention does not use three power-providing devices to respectively drive the ribbon transport module, the transfer paper transport module and the print roller. Since a single power-providing device is used to simultaneously drive the ribbon transport module, the transfer paper transport module and the print roller, the printing device of the present invention is more cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A printing device with a marking function, said printing device comprising:
a printing module for performing a printing operation to produce a barcode paper, and transporting said barcode paper;
an identification module disposed beside said printing module, and having a preset barcode image, wherein according to said preset barcode image, said identification module judges whether said barcode paper is identical to said preset barcode image;
a power-providing device connected with said printing module and said identification module for providing motive power to said printing module and said identification module; and
a marking member connected with said identification module, wherein if said identification module judges that said barcode paper is different from said preset barcode image, said marking member produces a mark on said barcode paper,
wherein said barcode paper is successively transported through said printing module, said identification module and said marking member.

2. The printing device with a marking function according to claim 1 wherein said printing module comprises:
a ribbon transport module for transmitting a ribbon from a ribbon supplying terminal to a ribbon recovering terminal;
a transfer paper transport module for transmitting a transfer paper from a transfer paper supplying terminal to a transfer paper recovering terminal, wherein said transfer paper comprises a releasing paper part and a medium part disposed on said releasing paper part;
a thermal print head arranged between said ribbon transport module and said transfer paper transport module for performing said printing operation on said medium part of said transfer paper through said ribbon, thereby printing said medium part as said barcode paper; and
a print roller arranged beside said thermal print head for transporting said transfer paper, so that said transfer paper is transmitted to said identification module.

3. The printing device with a marking function according to claim 2 wherein said ribbon transport module comprises:
a first tension shaft arranged between said ribbon supplying terminal and said thermal print head for applying a first tension force to said ribbon; and
a second tension shaft arranged between said thermal print head and said ribbon recovering terminal for applying said first tension force to said ribbon.

4. The printing device with a marking function according to claim 2 wherein said transfer paper transport module comprises:
a third tension shaft arranged between said transfer paper supplying terminal and said thermal print head for applying a second tension force to said transfer paper; and
a fourth tension shaft arranged between said thermal print head and said transfer paper recovering terminal for applying said second tension force to said transfer paper.

5. The printing device with a marking function according to claim 1 wherein said printing device further comprises a sensor, which is connected with said printing module for detecting a thickness of said transfer paper, wherein when said thickness of said transfer paper detected by said sensor is changed from a first thickness to a second thickness greater than said first thickness, said sensor issues a driving signal to said printing module to enable said printing module, wherein said first thickness is equal to a thickness of said releasing paper part, and said second thickness is equal to an overall thickness of said medium part and said releasing paper part.

6. The printing device with a marking function according to claim 1 wherein said identification module comprises:
a scanning element for scanning said barcode paper, thereby acquiring a scanned barcode image;
a controlling unit connected with said scanning element, and storing said preset barcode image, wherein by comparing said scanned barcode image with said preset barcode image, said controlling unit judges whether said scanned barcode image is identical to said preset barcode image;
a first transport roller assembly arranged at a first side of the scanning element for transporting said barcode paper through said scanning element; and
a second transport roller assembly arranged at a second side of said scanning element for transporting said barcode paper to be departed from the scanning element.

7. The printing device with a marking function according to claim 6 wherein said scanning element is a contact image sensor (CIS).

8. The printing device with a marking function according to claim 1 wherein said marking member comprises:
a marking head for producing a mark on said barcode paper; and
a solenoid valve connected with said marking head for moving said marking head upwardly and downwardly with respect to said barcode paper.

9. The printing device with a marking function according to claim 8 wherein said marking head is a seal, a punching head or a trimming knife, and said mark is an unqualified symbol, an opening or a notch.

10. The printing device with a marking function according to claim 1 wherein said printing device further comprises a gear set, wherein said gear set is connected with said power-providing device, said printing module and said identification module for receiving said motive power from said power-providing device, and transmitting said motive power to said printing module and said identification module.
